(19) United States
(12) Patent Application Publication
(10) Pub. No.: US 2007/0165965 A1
(43) Pub. Date: Jul. 19, 2007

(54) IMAGE PROCESSING METHOD AND PORTABLE COMMUCATION DEVICE

(75) Inventor: Chin-Hsien Hsieh, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/623,322

(22) Filed: Jan. 16, 2007

(30) Foreign Application Priority Data
Jan. 18, 2006 (TW) 95101883

(51) Int. Cl. G06K 9/20; G06K 9/36

(52) U.S. Cl. 382/283

(57) ABSTRACT

An image processing method suitable for an electronic device to receive a first image is provided. A controlling signal is received to generate a mask image. According to the controlling signal, the first image and the mask image are combined to generate a second image, wherein a portion of the first image is covered by the mask image. Then, the second image is outputted.

### CROSS-REFERENCE TO RELATED APPLICATION

This application claims the priority benefit of Taiwan application serial no. 95101883, filed Jan. 18, 2006. All disclosure of the Taiwan application is incorporated herein by reference.

### BACKGROUND OF THE INVENTION

1. Field of Invention

The present invention relates to a data processing method. More particularly, the present invention relates to an image processing method and an electronic device using the image processing method.

2. Description of Related Art

At present, if an image contains a caption, it is not easy for a user to separate the caption from the image, such as images of TV and video data of Video Compact Disc (VCD). Of course, in Digital Versatile Disc (DVD), a user can change languages of the caption or does not have the caption display. However, for separating captions from images, the user has to use DVD players and DVD discs.

An image and an caption can also be separated through an analysis to regions of the image by means of a complicated algorithm. However, this method needs a complicated circuit design. Or, a user can cover the caption with a piece of paper. Anyway, it is not a convenient way.

### SUMMARY OF THE INVENTION

Accordingly, the present invention is directed to provide an image processing method for covering particular regions of an image.

In addition, the present invention provides an electronic device for outputting an image with the covered regions.

The present invention provides an image processing method suitable for an electronic device to receive a first image. The image processing method includes the following steps. First, a controlling signal is received to generate a mask image. According to the controlling signal, the first image and the mask image are combined to generate a second image, wherein a portion of the first image is covered by the mask image.

In an embodiment of the present invention, the image processing method further includes outputting the second image.

In an embodiment of the present invention, the first image can have a caption, and the mask image covers the caption.

In an embodiment of the present invention, the method of combining the first image and the mask image can be the technology of On-Screen Display (OSD).

In an embodiment of the present invention, the controlling signal includes a size information of the mask image or a color information of the mask image.

In an embodiment of the present invention, the controlling signal includes information of the relative position between the mask image and the first image.

In an embodiment of the present invention, the electronic device can be a portable communication device.

For the above or other purpose, the present invention provides a electronic device suitable for receiving a first image. The electronic device includes a main module and a mask module, wherein the main module is used to receive a controlling signal. In addition, being coupled with the main module, the mask module is used to generate a mask image according to the controlling signal; the first image and the mask image are combined to generate a second image, wherein a portion of the first image is covered by the mask image.

In an embodiment of the present invention, the mask module includes a On-Screen Display (OSD) module.

In an embodiment of the present invention, the first image has a caption, and the mask image covers the caption.

In an embodiment of the present invention, the controlling signal includes a size information of the mask image or a color information of the mask image.

In an embodiment of the present invention, the controlling signal includes information of the relative position between the mask image and the first image.

In an embodiment of the present invention, the electronic device can be a portable communication device.

Based on the foregoing description, the present invention adopts the technology of image combination, such as OSD, to cover captions or particular regions of the original image, so that a user can easily control the portion of the original image which the user does not want it to show, such as the captions. Therefore, compared with conventional arts, the present invention can achieve the function of covering captions without a complicated circuit design.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flow chart of an image processing method of an embodiment of the present invention.

FIG. 2 is a system block diagram of an electronic device of an embodiment of the present invention.

### DESCRIPTION OF EMBODIMENTS

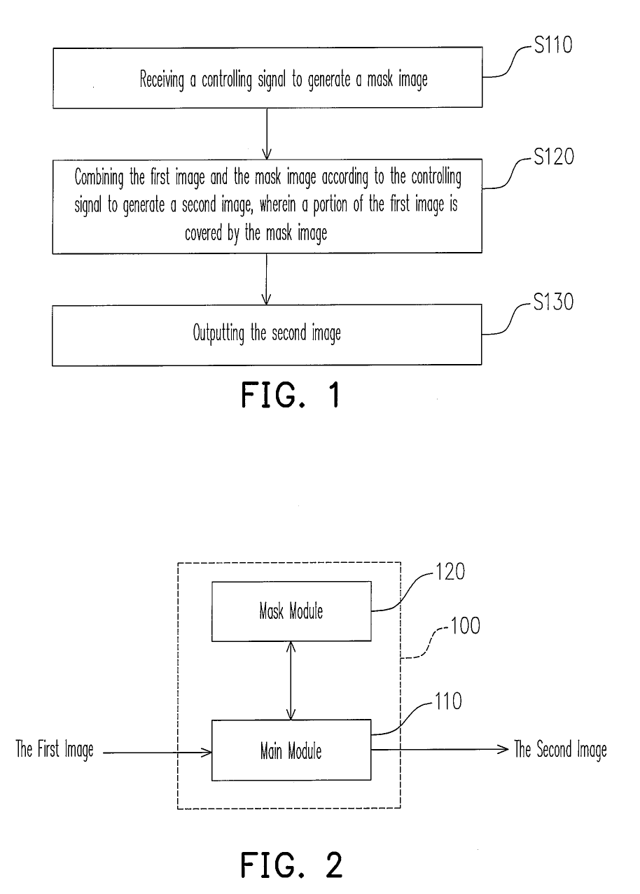

FIG. 1 is a flow chart of an image processing method of an embodiment of the present invention. Referring to FIG. 1, the image processing method of the present embodiment is suitable for an electronic device, such as a display or a portable communication device, wherein the portable communication device can be a mobile telephone complied with 3G specifications. In addition, a communication company uses the electronic device to receive a first image, which is, for example, a TV program sent by a cable TV station or a radio TV station, or a video data sent. The image processing method includes the following steps. First, in step S110, a controlling signal is received to generate a mask image, wherein the controlling signal is, for example, input by a user. Besides, the controlling signal includes the size or color of the mask image.

Next, in step S120, according to the controlling signal, the first image and the mask image are combined to generate a second image, wherein a portion of the first image is covered by the mask image. For example, when a user does not want to see a caption or other particular regions of the first image, he can set the position of the mask image to cover the caption or other particular regions of the first image. Namely, the controlling signal includes information of the relative position between the mask image and the first image. In addition, the method of combining the first image and the mask image can be the OSD technology or other image combination technologies. Last, in step S130, the second image is output.

Compared with conventional technologies in which captions are wiped off through complicated image analysis to the original image (the first image), the embodiment of the present invention adopts the technology of image combination to cover the particular regions (e.g. a caption) of the original image (the first image) to output a new image (the second image).

The following description takes an electronic device using the image processing method as an example.

FIG. 2 is a system block diagram of an electronic device of an embodiment of the present invention. Referring to FIG. 2, the electronic device 100 of the present embodiment includes a main module 110 and a mask module 120, wherein the main module 110 is coupled with the mask module 120. In addition, the mask module 120 is, for example, an OSD module.

For example, for covering a caption or other particular regions of the first image, a user can input a controlling signal to the main module 110 through a controlling interface such as a remote controller, a mouse, a button, or a keyboard. The main module 110 starts up the mask module 120 according to the controlling signal. At this time, the mask module 120 generates a mask image. Combining the first image and the mask image, the mask module 120 further generates a second image, wherein a portion of the first image is covered by the mask image. Then, the mask module 120 transmits the second image back to the main module 110 which then outputs the second image. So, the caption or particular regions of the second image will be covered by the mask image.

When the user wants to change the position, size and color of the mask image in the second image, he can input a controlling signal containing relative information to the main module110 through the controlling interface. According to the controlling signal, the mask module 120 controls the position, size and color of the mask image.

Although the present embodiment has been described with an example of an electronic device, the image processing method of the present embodiment can also be used in portable electronic devices, displays, or other image outputting device to cover captions or particular regions of images. Namely, the mask module 120 can be disposed in displays or other image outputting devices to provide the function of masking images. In addition, although the mask module 120 is integrated in the electronic device 100 in the present embodiment, it can also be used in a way of external hanging or external connecting with displays or other outputting devices to provide the function of masking images.

Based on the illustration above, the present invention adopts the technology of image combination, such as OSD, to cover captions or particular regions of original images, such that a user can easily control the portion of the original image which the user does not want it to show, such as a caption. Therefore, compared with conventional arts, the present invention can achieve the function of covering captions without a complicated circuit design.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordance with the scope of the following claims and their equivalents.

What is claimed is:

1. An image processing method for an electronic device to receive a first image, comprising:
receiving a controlling signal to generate a mask image; and
combining the first image and the mask image to generate a second image according to the controlling signal;
wherein a portion of the first image is covered by the mask image.

2. The image processing method as claimed in claim 1, further comprising outputting the second image.

3. The image processing method as claimed in claim 1, wherein the first image has a caption and the mask image covers the caption.

4. The image processing method as claimed in claim 1, wherein the method of combining the first image and the mask image comprises the technology of On-Screen Display (OSD).

5. The image processing method as claimed in claim 1, wherein the controlling signal comprises a size information of the mask image or a color information of the mask image.

6. The image processing method as claimed in claim 1, wherein the controlling signal comprises information of the relative position between the mask image and the first image.

7. The image processing method as claimed in claim 1, wherein the electronic device is a portable communication device.

8. An electronic device, suitable for receiving a first image, comprising:
a main module for receiving a controlling signal; and
a mask module coupled the main module for generating a mask image according to the controlling signal and combining the first image and the mask image to generate a second image, wherein a portion of the first image is covered by the mask image.

9. The electronic device as claimed in claim 8, wherein the mask module comprises an On-Screen Display module.

10. The electronic device as claimed in claim 8, wherein the first image has a caption and the mask image covers the caption.

11. The electronic device as claimed in claim 8, wherein the controlling signal comprises a size information of the mask image or a color information of the mask image.

12. The electronic device as claimed in claim 8, wherein the controlling signal comprises information of the relative position between the mask image and the first image.

13. The electronic device as claimed in claim 8, wherein the electronic device is a portable communication device.
